(19) United States
(12) Patent Application Publication
(10) Pub. No.: US 2017/0116165 A1
(43) Pub. Date: Apr. 27, 2017

(54) SYSTEM AND METHOD FOR WEBSITE CONTENT MANAGEMENT

(71) Applicant: Osmnez Technologies Inc., Walnut, CA (US)

(72) Inventors: Arvind PARTHIBAN, Chennai (IN); Naveen VENKATESAN, Chennai (IN); Santhosh Kumar SUGUMARAN, Chennai (IN)

(73) Assignee: Osmnez Technologies Inc., Walnut, CA (US)

(21) Appl. No.: 15/333,589

(22) Filed: Oct. 25, 2016

(30) Foreign Application Priority Data
Oct. 25, 2015 (IN) 5714/CHE/2015

(51) Int. Cl. G06F 17/22; G06F 3/0482; G06F 17/24; H04L 29/08

(52) U.S. Cl. CPC G06F 17/2288; H04L 67/02; H04L 67/22; H04L 67/306; G06F 3/0482; G06F 17/24; G06F 17/2211

(57) ABSTRACT

A content management system for managing content on a selected website is provided. The system includes a user system configured to send a request for a browser module. The system further includes a server configured to receive the request and transmit the browser module to the user system. In addition, the system comprises of the browser module configured to reside on a browser installed on the user system. The browser module is configured to enable a user to select an experiment from a plurality of experiments. In addition, the browser module is configured to edit one or more portions of the selected website to generate one or more variations of the selected website. Further, the browser module executes the experiment on the selected website and the one or more variations. Furthermore, a report is generated by the browser module by comparing a plurality of variables between the selected website and the one or more variations.

### PRIORITY STATEMENT

The present application hereby claims priority to Indian patent application number 5714/CHE/2015 filed Oct. 25, 2015, the entire contents of which are hereby incorporated herein by reference.

### BACKGROUND

The invention relates generally to a website content management system and more particularly to a system and method configured to manage content on a selected website using a browser module installed on a web browser.

Typically, content on website viewed through a browser include advertisements, photographs, banners, and other similar material. A website's conversion rate is a measure of how successfully the website persuades visitors to act on what is offered. Thus, website operators are often challenged to maximize conversion rates of the website such as number of visitors who make a purchase, register for a new account, sign-up for a newsletter, submit a sales lead, and adopt a website feature etc.

The conversion process normally includes numerous websites and links. Website operators always strive to communicate in a best possible manner to the website's visitors. Also, the content on each website must compel the visitor browse through the website. For this, the website operator needs to test variations of website content like product descriptions, headlines, calls to action, assurance messages, images, and words that aid site navigation and usability to determine which are most persuasive to visitors.

In the conventional approach for evaluation of websites, the website to be evaluated is loaded into a service provider's tool for testing. Further, several web evaluation techniques like A/B testing, split URL testing and heat-map analysis are employed for measuring and analyzing the actions and behavior of visitors.

However, in these approaches users have to load the URLs of the websites to be evaluated on the service provider's tool. This makes the website susceptible to security issues. Also, in case of signed in websites' additional authentication is required and hence the websites cannot be loaded. There is a considerable time lag while loading websites especially heavy ones on the service provider's tool and hence prevents users from testing such websites.

Further, heat-map analysis for dynamic content on websites such as sliding images, banners etc. cannot be provided. This is because the service providers usually take snapshots of the website to be analyzed providing a static analysis, but clicks on the additional banners/images which are not a part of the snapshot are ignored. Moreover, website debugging and tailoring is a tedious process for a client since it requires immense technical knowledge in order to make changes to the source code of the website and hence requires technical expertise even for making few changes.

Therefore there is a need for a faster, simpler and more effective system and method for managing content on a website

### SUMMARY

The following summary is illustrative only and is not intended to be in any way limiting. In addition to the illustrative aspects, example embodiments, and features described above, further aspects, example embodiments, and features will become apparent by reference to the drawings and the following detailed description. Example embodiments provide a website content management system configured to manage content on a client browser.

Briefly, according to an example embodiment, a content management system for managing content on a selected website is provided. The system includes a user system configured to send a request for a browser module. The system further includes a server configured to receive the request and transmit the browser module to the user system. The browser module is configured to reside on a browser installed on the user system. The browser module is configured to enable a user to select an experiment from a plurality of experiments. Further, the browser module is configured to enable the user to edit one or more portions of the selected website and generate one or more variations. Further, the browser module executes the experiment on the selected website and the one or more variations. A report is generated by the browser module by comparing a plurality of variables between the selected website and the one or more variations.

Example embodiments provide a method for managing content on a selected website. The method comprises installing a browser module on a desired browser of a user system and creating an experiment from plurality of experiments. The method further comprises editing one or more portions of the selected website to generate one or more variations and defining a goal and a target audience for the experiment. The method further includes executing the experiment on the selected website and the one or more variations is facilitated. The experiment is executed in real-time and a report is generated. The report includes a plurality of variables between the selected website and the one or more variations that provides a comparison of the selected website and the variations.

According to yet another embodiment, a non-transitory computer readable medium having instructions encoded thereon for execution by a processor is provided. The instructions comprise of code to facilitate a user to create an experiment from a plurality of experiments and to facilitate editing of one or more portions of the selected website to generate one or more variations. A plurality of goals and a target audience is defined for the created experiment. Furthermore, the instructions include code to execute the selected experiment and compare a plurality of variables of the selected website and the variation website.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating one embodiment of a content management system configured to manage content on a website, implemented according to aspects of the present technique;

FIG. 2 is a flow chart illustrating one method for evaluating, altering and controlling content of a website, implemented according to aspects of the present technique;

FIG. 3 is an example screen illustrating the browser module installed on to the user system, implemented according to aspects of the present technique;

FIG. 4 is an example screen illustrating creation of one or more variations of the website, implemented according to aspects of the present technique;

FIG. 5 is an example screen illustrating a visual editor implemented according to aspects of the present technique;

FIG. 6 is an example screen illustrating creation of one or more goals, implemented according to aspects of the present technique;

FIG. 7 is an example screen illustrating selection of audience to be targeted, implemented according to aspects of the present technique;

FIG. 8 is an example screen illustrating the summary of an experiment, implemented according to aspects of the present technique;

FIG. 9 is an example heat map report, according to aspects of the present invention; and

FIG. 10 is an example screenshot of the report generated, according to aspects of the present invention.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” may encompass both an orientation of above and below. The device may be otherwise oriented (rotated 90 degrees or at other orientations) and the spatially relative descriptors used herein are interpreted accordingly.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The device(s)/apparatus(es), described herein, may be realized by hardware elements, software elements and/or combinations thereof. For example, the devices and components illustrated in the example embodiments of inventive concepts may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the example embodiments of the inventive concept described below may be implemented with program instructions which may be executed by computer or processor and may be recorded in computer-readable media. The media may also include, alone or in combination with the program instructions, data files, data structures, and the like. The program instructions recorded in the media may be designed and configured especially for the example embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to execute one or more software modules to perform the operations of the above-described example embodiments of the inventive concept, or vice versa.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

At least one example embodiment is generally directed to a content management system configured to manage content on a website. Example embodiments of the present technique provide a content management system and method facilitating a user to select one or more experiments and to apply the selected experiments on a selected website of the client browser to evaluate and edit one or more portions of the website. The working of the above mentioned website content management system is described in detail below.

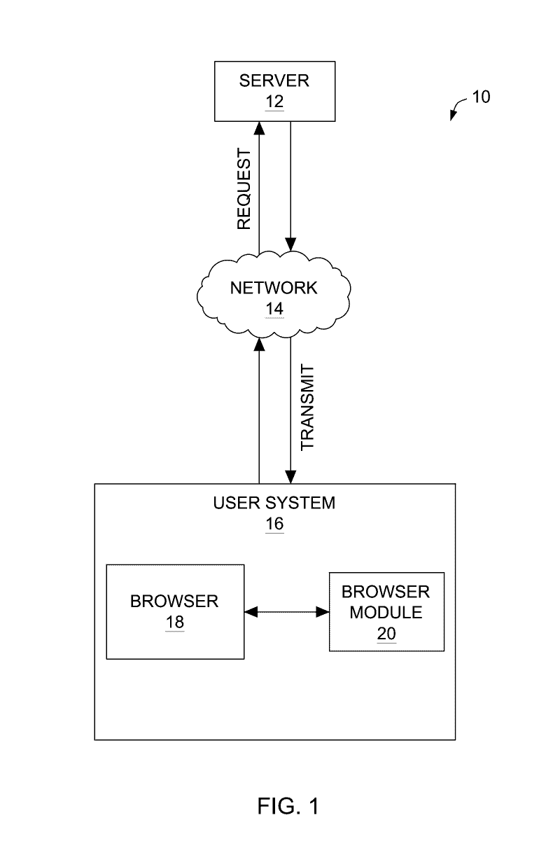

FIG. 1 is a block diagram illustrating one embodiment of a content management system configured to manage content on a website, implemented according to aspects of the present technique. The content management system 10 includes user system 16 coupled to a server 12 through a network 14. Each block is described in further detail below.

User system 16 is a general purpose computing device that is used to perform a variety of computing processes. One of the many tools installed in the user system is web browser. In general, a web browser is a software tool for retrieving, presenting, and traversing information resources present on the World Wide Web. According to aspects of the present technique, in order to manage content on a selected website, the user system may send a request to a server for transmission of a browser module.

Server 12 is configured to receive the request for a browser module 20 from the user system 16. The server 12 is further configured to transmit the browser module 20 to the user system through network 14. In one embodiment, the browser module is transmitted in exchange for a payment.

Browser module 20 is configured to facilitate a user to manage the content of one or more selected portions of the website. The browser module is also configured to provide a selection of experiments to the user. The user may create variation of the selected website using a number of editing tools that are present in the browser module. In one embodiment, the experiments are performed to compare a plurality of variables associated with the different variations and the original selected website. The manner in which the content of the website is altered and compared is described in further detail below.

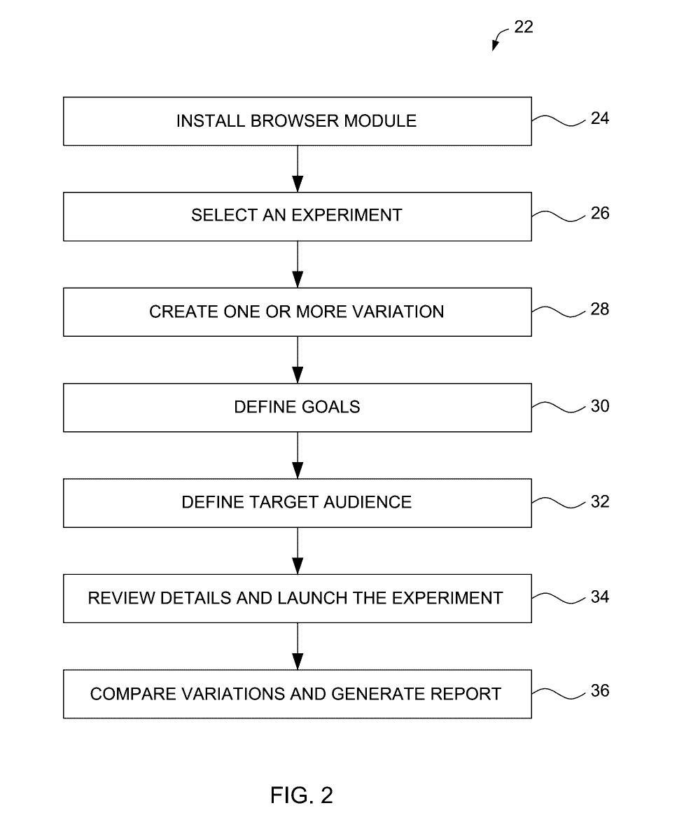

FIG. 2 is a flow chart illustrating one method for evaluating, altering and controlling content of a website, implemented according to aspects of the present technique. The content on the selected website is managed and evaluated using a browser module. The browser module follows several steps which is described in further detail below.

At step 24, a user system sends request to the server for browser module. The server transmits the browser module and is installed on to the user system's preferred browser. The browser module may be transmitted as an executable file that can be installed on the user system. In one embodiment, the executable file is downloaded via the Internet. Once installed, a browser module icon appears on a browser panel of the browser. The browser module provides a user with a set of experiments.

At step 26, the user selects an experiment to be created from the set of experiments. Examples of experiments include A/B testing, split URL, heat-map and Scroll-map experiments, and the like. For conciseness, the examples listed below are with reference to an A/B testing experiment.

At step 28, one or more variations of a website are created. As used herein, a variation refers to an edited version of the selected website. In one embodiment, a variation is generated by editing a selected portion(s) of the website. In one embodiment, the original website is edited by using a visual editor present in the broswer module. The visual editor provides multiple options for editing the website. The changes may range from changing button colors to changing images and may even be complex changes involving multiple parameters. In one example embodiment, the options provided by the visual editor for creating the variation include, but are not limited to, changing text, text color, background color, moving a particular element, rearranging the elements, resizing, editing, selecting parent or combinations thereof.

At step 30, one or more goals are defined for tracking a set of defined parameters. In one embodiment, each goal is defined by tracking parameters such as engagement, elements on the selected website like buttons, clicks on links available on the website, number of visits to the website, number of clicks on a particular element of the website, number of successful submission of forms and so on. Also, additional goals can be created and added for tracking. Further, the user may select a primary goal from a list of defined goals.

At step 32, an appropriate target audience is selected based on one or more criteria. The various options available for the selection of target audience include all visitors, visitors directly entering the client website address in the browser, visitors coming to client website by clicking links, buttons etc. from other websites, visitors coming through social media like Facebook, twitter, Linkedn etc. Further, custom audience segments can also be created based on various parameters like age groups, demographics and the like.

At step 34, the summary of the selected options is checked and the created experiment is launched. The summary includes all the selected variables of the test such as variations, goals and targeted audience. In one embodiment, the user may review all the steps and make changes if required, before launching the experiment.

At step 36, the variations are compared and a report is generated. Depending on the hypothesis of the experiment, the variation(s) will be tested against the original page (without changes) to identify the best performing variation. This is achieved by comparing different variables of the variation(s) with the original page. A report is generated comparing a plurality of variables between one or more variations and the original website. The plurality of variables is used to compute a conversion rate for each variation to identify the best performing variant. The manner in which the user selects the various options on the browser module is described in further detail below.

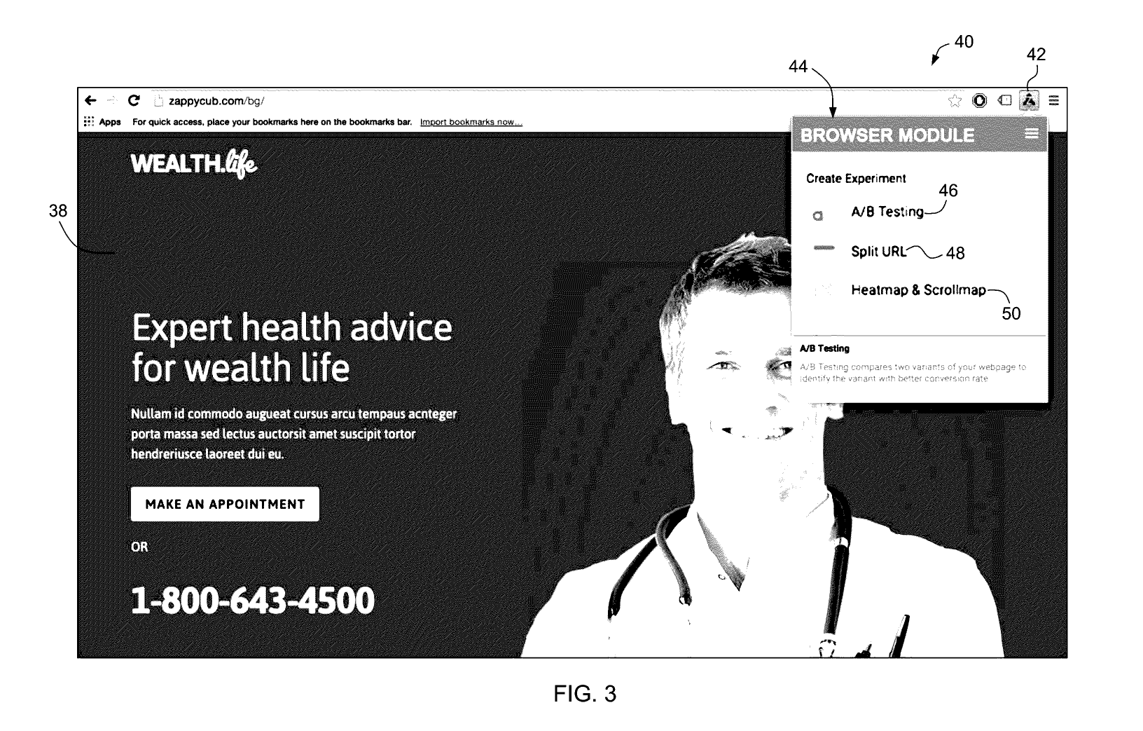

FIG. 3 is an example screenshot illustrating an embodiment of a browser module installed on a web browser, implemented according to aspects of the present technique. As illustrated in screen 40, the browser module is installed on to the user's preferred web browser. In the illustrated embodiment, the preferred web browser is the Chrome browser. The user may implement the browser module to test a selected website 38. As is shown, on clicking the browser module icon 42 on the browser, a small window 44 appears on the screen 40. Window 44 provides a list of experiments that a user may select. In one embodiment, the set of experiments include A/B testing 46, split URL 48 and heat-map experiment 50.

AB test is an experiment that is used to test two variations of a website. This allows the incoming visitor traffic to be divided amongst the variations. At the end of the test, the variation with the maximum conversion rate is usually adopted as the standard. It may be noted that the test is not limited to two variation and multiple variations may also be created as required.

The browser module may further facilitate a split URL test. In the split URL test, unlike A/B test, the variations are necessarily housed on different URLs. Split URL test is used when the website designs are very different from each other. Thus, A/B test is preferred when only front end changes are required while split URL test is preferred when backend or significant design changes are necessary.

The browser module may further facilitate the generation of a heat map which is a two-dimensional representation of data in which values are represented by colors. A simple heat map provides an immediate visual summary of information. More elaborate heat maps allow the viewer to understand complex data sets. There can be many ways to display heat maps, but they all share one thing in common that is use of color to communicate relationships between data values that would be much harder to understand if presented numerically in a spreadsheet. Web heat maps have been used for displaying areas of a website most frequently scanned by visitors. Web heat-maps are often used alongside other forms of web analytics to provide the exact location of clicks and intensity of clicks on the location in a visual manner.

Upon selecting an experiment from the set of experiments, the user is guided to the next step in the process, which is to create variations of the selected website. The manner in which the variations are create is described in further detail below.

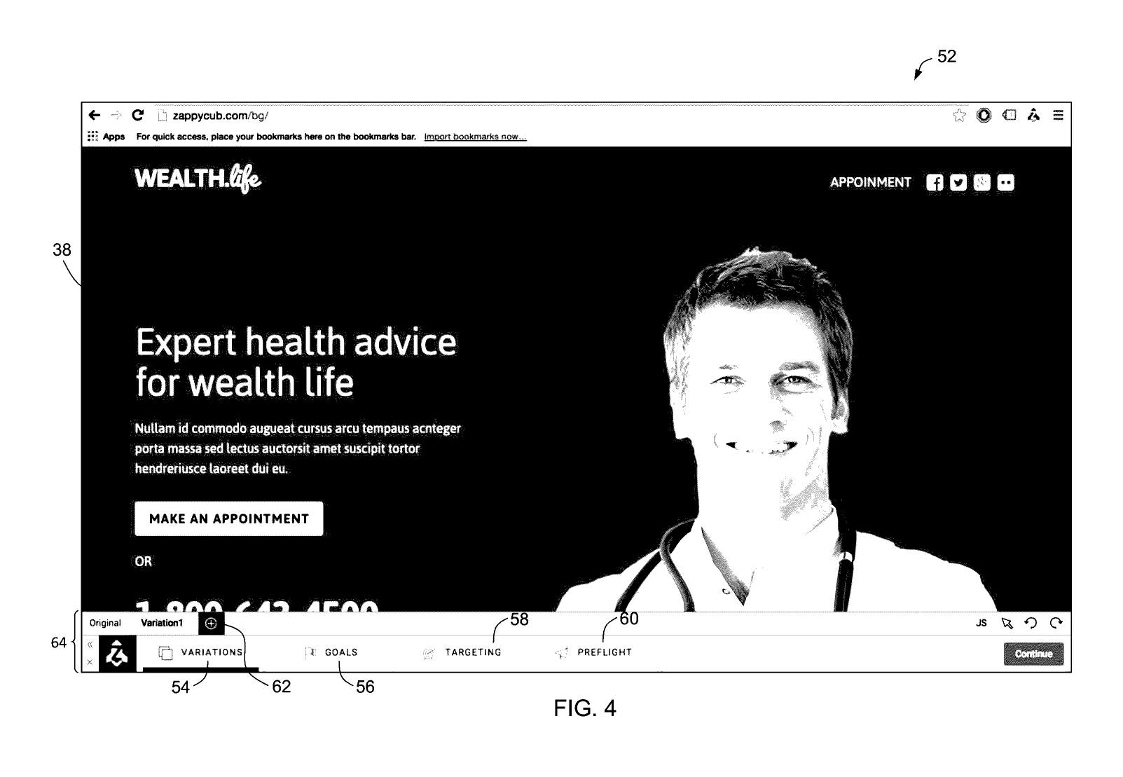

FIG. 4 is an example screenshot illustrating a manner in which one or more variations of the website is created, implemented according to aspects of the present technique. It may be noted that many variations can be created for the selected website if so desired.

It is assumed that the user selects the A/B testing experiment as shown in FIG. 3. On selecting the A/B testing experiment, various tabs appear at the bottom (mentioned by reference numeral 64) of the website as shown in screen 52. Such tabs include VARIATIONS 54, GOALS 56, TARGETING 58 and PREFLIGHT 60. A variation page Variationl is created by default. A plurality of variations of the selected website could be created by clicking on “+” option referred generally by reference numeral 62. Variations are created by editing one or more portions of the selected website 38. The manner in which the website is edited is described in further detail below.

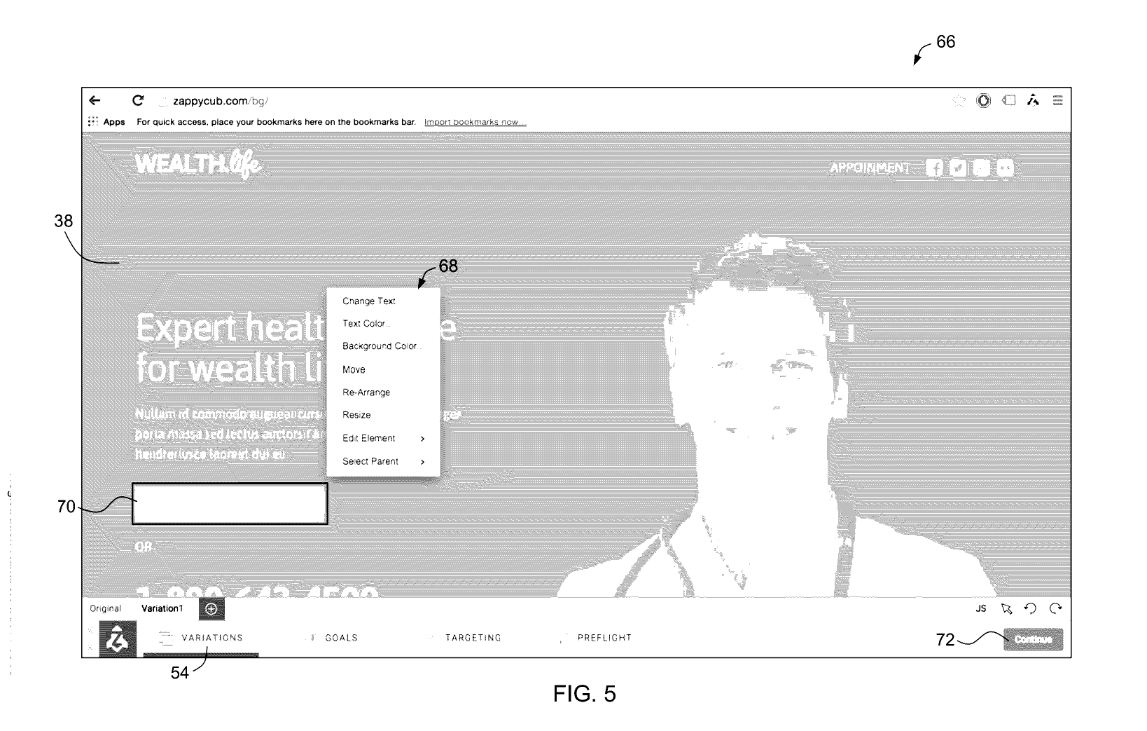

FIG. 5 is an example screenshot illustrating a visual editor for editing a selected website, implemented according to aspects of the present technique. The visual editor 68 is configured to facilitate a user to editing nr or more portions of the selected website displayed on the screen 66. The visual editor 68 provides plurality of options for editing the website as is described below.

In the illustrated example, for a selected portion (referred by reference numeral 70), the plurality of options provided by the visual editor 68 for creating a variation include changing text, text color, background color, moving a particular element, rearranging the elements, resizing, editing, selecting parent or combinations thereof. Once desired variations are created, user can move to next tab GOALS by clicking on ‘Continue’ button 72. The manner in which goals are defined for an experiment is described in further details below.

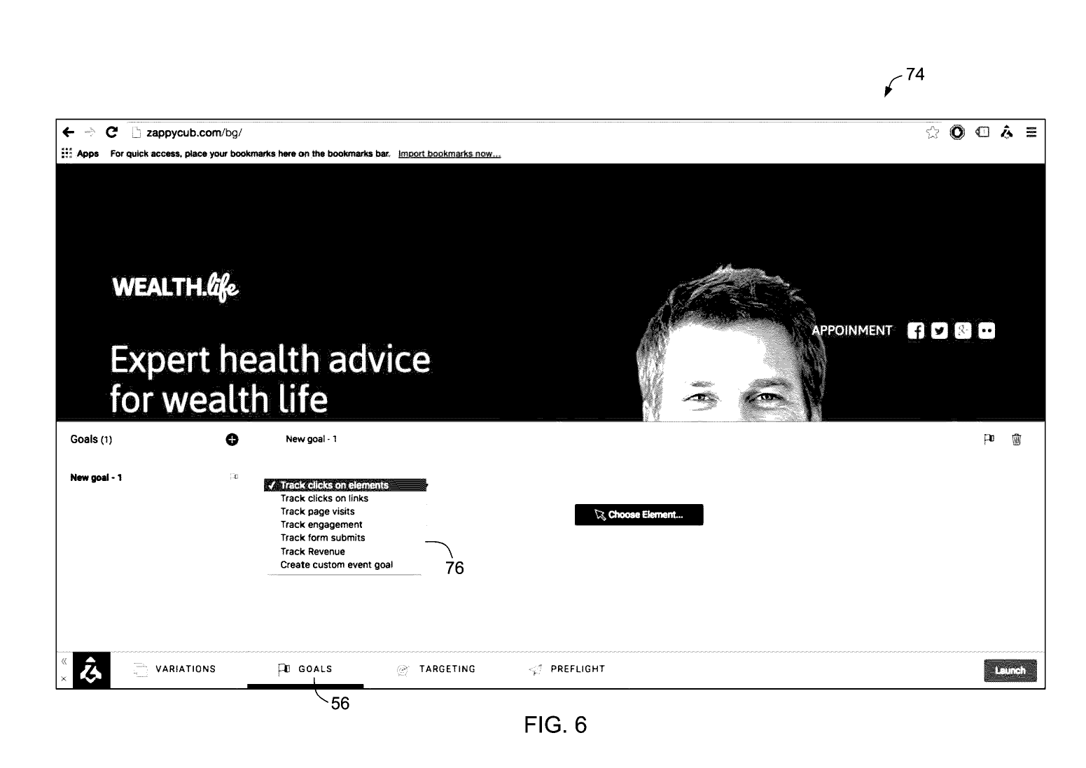

FIG. 6 is an example screenshot illustrating a manner in which goals are defined for a selected experiment, implemented according to aspects of the present technique. By clicking the “GOALS” tab 56, a drop down window 76 providing various options is displayed. User can select from the options to define the goals. Each goal can be defined by tracking various variables provided by the dropdown window 76 such as engagement, elements on the website like buttons, clicks on links available on the website, number of visits to a particular website, number of clicks on a particular element of a website, number of successful submission of forms and so on. By clicking on the “TARGETING” tab the user can navigate to the next screen. The manner in which a target audience is selected is described in further details below.

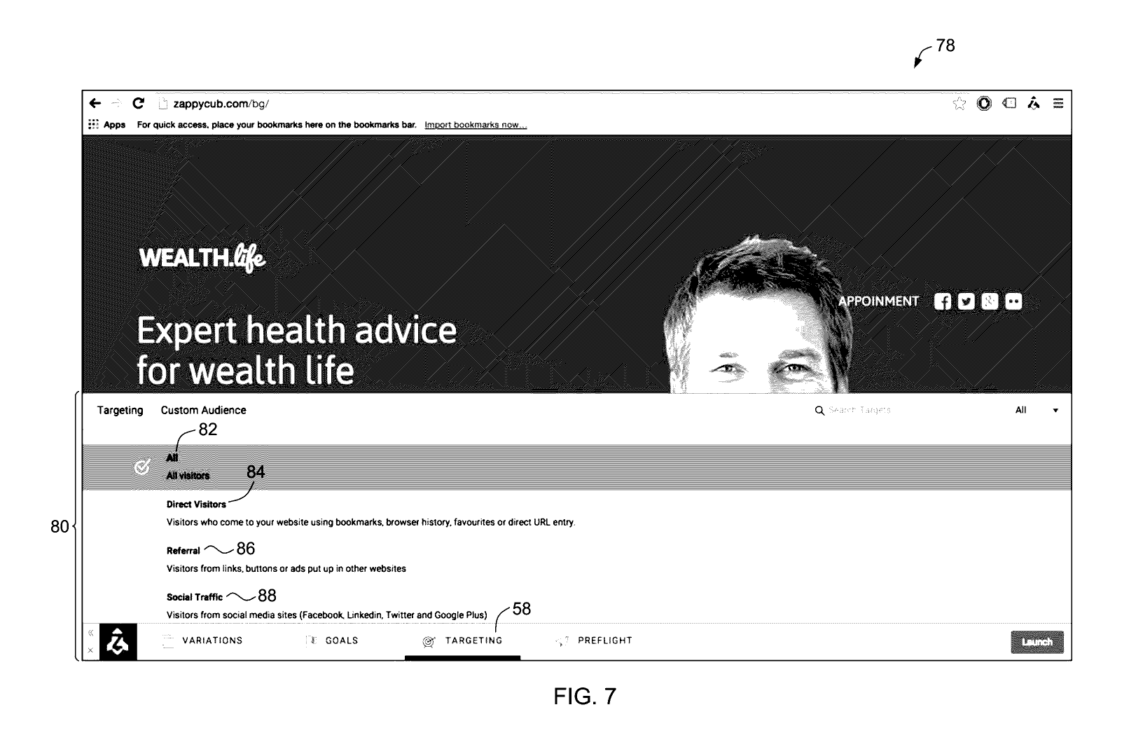

FIG. 7 is an example screenshot illustrating a manner in which a target audience is selected using a browser module, implemented according to aspects of the present technique. The target selection screen 80 facilitates the user to select appropriate target audience based on one or more criteria. As depicted, in this example embodiment, the various options available for the selection of target audience include ‘All visitors’ 82, ‘Direct visitors’ 84, ‘Referral’ 86 and ‘Social traffic’ 88. Direct visitors visit the website through URL, bookmarks, browser history or favorites. Referral include visitors from links, buttons etc. from other websites. Social traffic includes the audience coming through social media like Facebook, Twitter, LinkedIn, Google Plus and the like. Various other parameters such as operating system, query parameter, cookie value and the like are used to define a target audience. By clicking on the “PREFLIGHT” tab, the user can navigate to the next screen. The manner in which the summary is reviewed and the created experiment is launched is described in further details below.

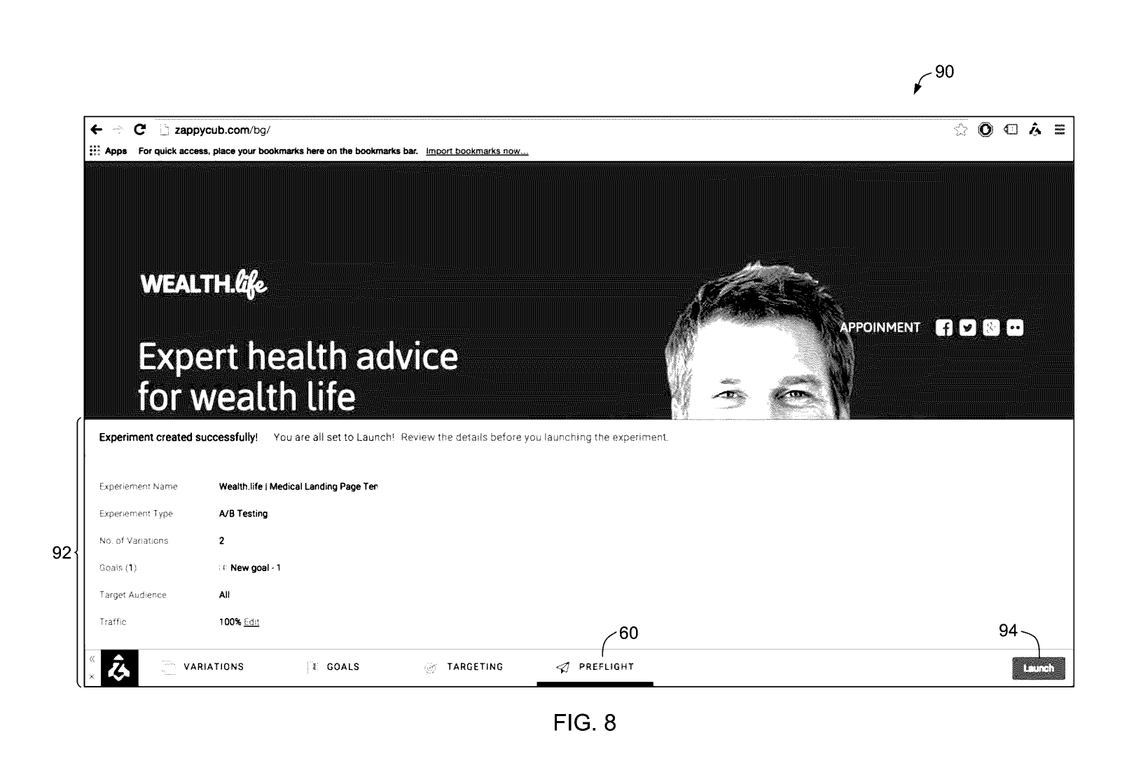

FIG. 8 is an example screen illustrating the summary of an experiment, implemented according to aspects of the present technique. The preflight screen 92 provides a summary of the selected options of the experiment to be launched. In this example embodiment, the summary includes several parameters like experiment name, experiment type, number of variations, goals, target audience and traffic. The user can set traffic as per requirement and can also control/edit the traffic of the selected websites using the ‘Edit’ link provided on the preflight screen 92. Once the summary of the experiment is reviewed, the experiment is launched by clicking on the ‘Launch’ button 94.

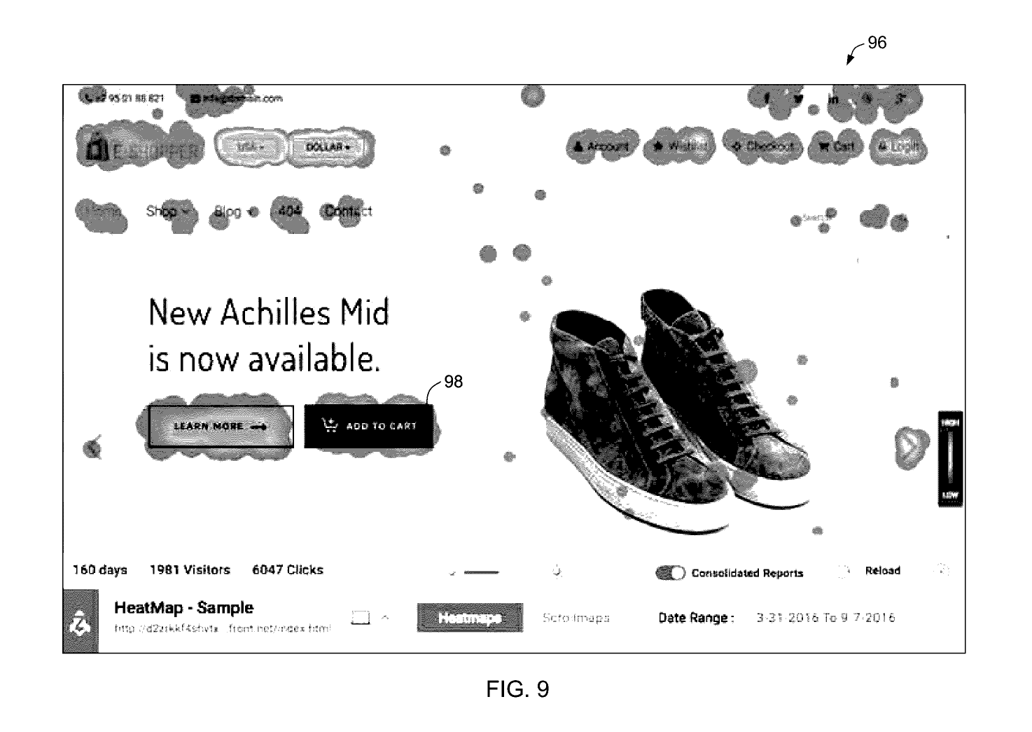

The above mentioned figures as described with reference to A/B testing evaluation technique. However, when user has selects the heat map experiment, the browser module facilitates the generation of a heat map. FIG. 9 illustrates an example heat map generated by heat map technique. Heat map is a two-dimensional representation of data in which values are represented by a corresponding color. In an example embodiment, web heat-maps provides the exact location of clicks and intensity of clicks on the location in a visual. For example, the area 98 around the “ADD TO CART” button is color marked indicating frequent clicks. The use of color communicates relationships among data values. The most frequently scanned areas of a website by the visitors are color marked and the exact location of clicks and intensity of clicks on the location is provided in a visual manner. A consolidated report is generated after the created experiment is launched. The manner in which the report is viewed is described further below.

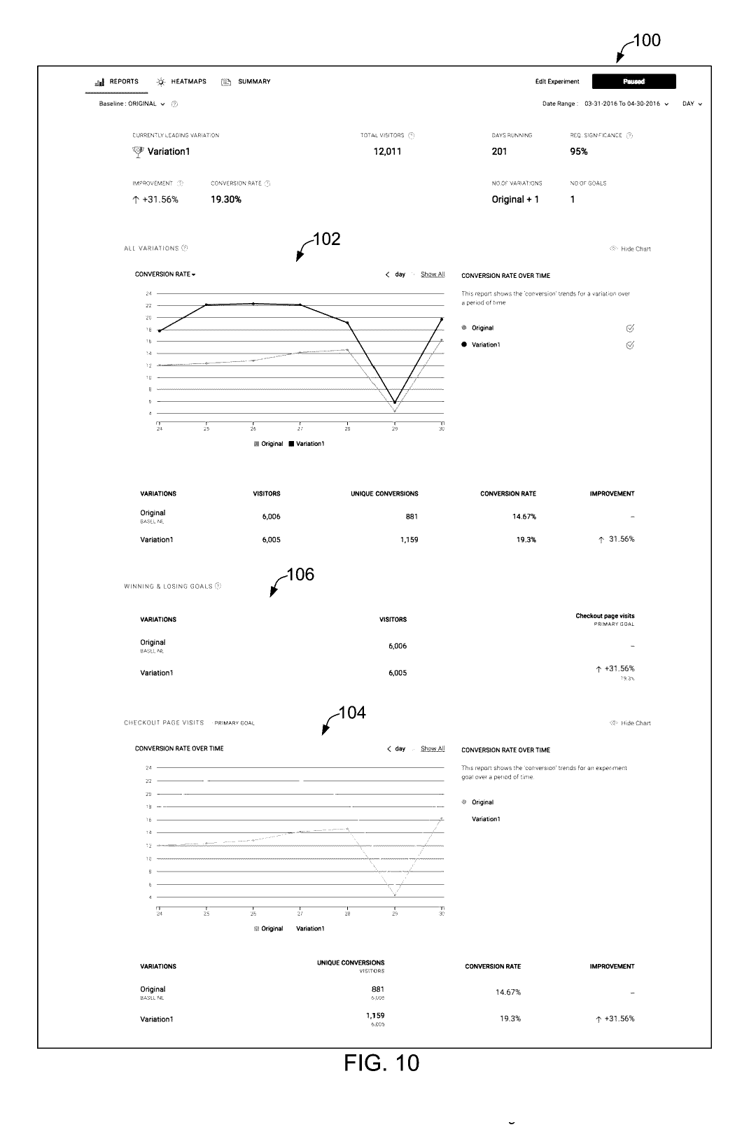

FIG. 10 is an example screenshot of the report generated, according to aspects of the present invention. Once the created experiment is launched, the browser module generates a report comparing a plurality of variables between one or more variations and the original website. The plurality of variables is used to compute a conversion rate for each variation to identify the best performing variant. The conversion rate is the percentage of visitors taking desired action. For example, on an e-commerce site, it is the percentage of website visitors making successful purchases.

In one embodiment, the report 100 generates a graph 102 showing the conversion trends for a variation over a period of time. In addition, a graph 104 shows the conversion trends for an experiment over a period of time. The conversion trend data is also provided in the tabulated form below each graph. Moreover, winning and losing goal data is also provided by the report (referred by reference numeral 106). By viewing statistics associated with several variations, user can determine which variation attracts more visitor traffic. The different variations of the website may provide substantially the same content but use different presentations.

The above described technique provides many advantages including an easy and quick method to edit one or more portions of a website. The browser module allows theuser to create various experiments to evaluate if the selected website requires any chages. The report also provides a comprehensive understanding to the user on what variation will fetch an optimum conversion rate.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A content management system for managing content on a selected website, the content management system comprising:
a user system configured to send a request for a browser module;
a server configured to receive the request and transmit the browser module to the user system;
the browser module configured to reside on a browser installed on the user system; wherein the browser module is configured to:
enable a user to select an experiment from a plurality of experiments;
edit one or more portions of the selected website to generate one or more variations of the selected website;
execute the experiment on the selected website and the one or more variations;
generate a report comparing a plurality of variables between the selected website and the one or more variations.

2. The content management system of claim 1, wherein the browser module further comprises a visual editor configured to enable the user to select and edit one or more portions of the selected website

3. The content management system of claim 1, wherein the browser module is further configured to enable the user to define a plurality of goals for the experiment.

4. The content management system of claim 1; wherein the browser module is further configured to enable the user to define a target audience for the selected experiment.

5. The content management system of claim 4, wherein the browser module is configured to track a plurality of visitor profiles associated with the selected website.

6. The content management system of claim 5, wherein the browser module is configured to categorize the visitor profiles based on at least one of demographic information, usage patterns and age group.

7. The content management system of claim 1, wherein the pluralities of variables comprise a conversion rate; wherein the conversion rate is defined by the user.

8. The content management system of claim 5, wherein the experiments are executed real-time.

9. The content management system of claim 1, wherein the browser module is configured to generate a heat map, wherein the heat map represents a distribution of clicks on the selected website and the one or more variations.

10. A method for managing content on a selected website, the method comprising:
installing a browser module on a desired browser of a user system;
creating an experiment from a plurality of experiments;
editing one or more portions of the selected website to generate one or more variations of the selected website;
defining a goal and a target audience for the experiment;
executing the experiment on the selected website and the one or more variations; wherein the experiment is executed real-time;
generating a report comparing a plurality of variables between the selected website and the one or more variations.

11. The method of claim 10, wherein the editing comprises editing the one or more portions of the selected website using a plurality of visual parameters.

12. The method of claim 10, further comprising tracking a plurality of visitors of the selected website.

13. The method of claim 12; further comprises generating a heat map and a scroll map for the selected website.

14. A non-transitory computer readable medium having instructions encoded thereon for execution by a processor, the instructions comprising code to:
facilitate a user to create an experiment from a plurality of experiments;
edit one or more portions of the selected website to generate one or more variations,
define a plurality of goals and a target audience for the created experiment;
execute the selected experiment and compare a plurality of parameters of the selected website and the variation website.

15. The non-transitory computer readable medium of claim 14, wherein code to edit one or more portions of the selected website comprises code to alter a plurality of visual parameters of the selected website.
